(19) United States
(12) Patent Application Publication
(10) Pub. No.: US 2006/0111882 A1
(43) Pub. Date: May 25, 2006

(54) Unified and localized method and apparatus for solving linear and non-linear integral, integro-differential, and differential equations

(76) Inventor: Muralidhara Subbarao, Stony Brook, NY (US)

Correspondence Address: MURALIDHARA SUBBARAO, 95 MANCHESTER LN, STONY BROOK, NY, 11790, US

(21) Appl. No.: 11/242,191

(22) Filed: Oct. 3, 2005

Related U.S. Application Data
(60) Provisional application No. 60/630,395, filed on Nov. 23, 2004.
(60) Provisional application No. 60/631,555, filed on Nov. 29, 2004.

(51) Int. Cl. G06F 17/10

(52) U.S. Cl. 703/2

(57) ABSTRACT

This invention is based on a new class of mathematical transforms named Rao Transforms invented recently by the author of the present invention. Different types of Rao Transforms are used for solving different types of linear/non-linear, uni-variable/multi-variable integral/integro-differential equations/systems of equations. Methods and apparatus that are unified and computationally efficient are disclosed for solving such equations. These methods and apparatus are also useful in solving ordinary and partial differential equations as they can be converted to integral/integro-differential equations. The methods and apparatus of the present invention have applications in many fields including engineering, science, medicine, and economics.

This patent application is a continuation of the following two Provisional Patent Applications filed by this inventor:
1. M. SubbaRao, “Method and apparatus for solving linear and non-linear integral and integro-differential equations”, USPTO Application No. U.S. 60/630,395, Filing date: Nov. 23, 2004; and
2. M. SubbaRao, “Unified and Localized Method and Apparatus for Solving Linear and Non-Linear Integral, Integro-Differential, and Differential Equations”, USPTO Application No. U.S. 60/631,555, Filing date: Nov. 29, 2004.
   This patent application is substantially and essentially the same as the second Provisional Patent Application above. The main differences are in changes in terminology and more detailed description of the method of the present invention. The fundamental basis of this patent application, which is the invention of the Rao Transform and General Rao Transform, remains exactly the same as the two provisional patents listed above.

### 1.1 BACKGROUND OF THE INVENTION

Two novel mathematical transforms—Rao Transform (RT) and General Rao Transform (GRT)—have been invented. They are useful in solving a large class of linear/non-linear integral/integro-differential equations, and in the analysis of systems/processes modeled by such equations. For example, RT and GRT can be used to compute the output given the input, and also compute the input given the output, of linear/non-linear integral/integro-differential systems/processes. RT and GRT provide a novel and unified theoretical foundation and computational framework. The theoretical basis is simple and elegant leading to new insights. The computational framework is non-iterative and efficient. Therefore, RT and GRT offer immense advantages in theoretical studies and practical applications, particularly in problems Involving compact kernels. The areas of application include
image and signal processing (e.g. image/video restoration, filtering),
computer vision (e.g. 3D vision sensor),
optics (e.g. computing the image formed by a lens system),
inverse optics (e.g. inverting the image formation process in a lens system to obtain a 3D scene model)
mathematical software (e.g. MatLab, Mathematica),
analysis of linear and non-linear integral systems, and
scientific and medical instrumentation.

This invention is a fundamental theoretical and computational breakthrough that may lead to a paradigm shift in solving many practical problems. In addition to providing a novel approach, this invention suggests using RT and GRT to rederive existing techniques of solving integral equations, potentially resulting in new insights and computational advantages.

### 1.2 DESCRIPTION OF PRIOR ART

Integral and integro-differential equations arise in almost every area of engineering, medicine, science, economics, and other fields. Numerous techniques have been proposed for solving these equations so far. However, in the current research literature, there is no unified theory and method which is useful in practical applications for solving general integral equations. Solution methods for different cases are disconnected, lacking a common framework. There are special methods for Fredholm-type and Volterra-Type, “First Kind”, and “Second Kind”, linear, and non-linear, symmetric kernels, and separable kernels, etc. Some well known methods are—Fredholm's method (determinants), Volterra's method (iterated kernels, Neuman series), ortho-normal series expansion, undetermined coefficients or power series expansion, numerical quadrature (e.g. Nystrom) methods, etc. These techniques suffer from one or more of the following drawbacks or limitations. Many techniques are computationally very expensive to the extent that they are impractical. Some techniques are iterative in nature, or numerically unstable, i.e. a small change in the input data causes a large change in the output data. Other techniques are applicable to only a very narrow and specific problem (e.g. separable kernels). Some techniques may not be easily extensible to more than one or two dimensions. There are techniques that use heuristics such as regularization to ensure stability and uniqueness. Some techniques provide only approximate solutions.

The method in this patent application is unified in the sense that many different types of both linear and non-linear integral, integro-differential, and differential equations, are all solved by a common approach. The method is localized in the sense that the solution at a point depends mainly on the information in a small interval around that point. This unified and localized method offers many advantages relative to other known methods.

In the case of linear integral/integro-differential equations, the method of the present invention provides a solution that is explicit, closed-form, non-iterative, deterministic, and localized in a certain sense that makes it possible to be implemented on parallel/distributed computing hardware. The localized nature of the method of the invention is expected to bring other advantages such as numerical stability and accuracy (fast convergence). In the case of non-linear integral/integro-differential equations, the method of the present invention provides a solution by solving a system of non-linear algebraic equations.

Much useful information on different methods for solving integral equations can be obtained by searching the world-wide web with key words such as “integral equation”, Fredholm, Volterra, etc. One example of a useful website is the following:
Eric W. Weisstein. “Integral Equation.” From Mathworld, A Wolfram Web Resource. http://mathworld.wolfram.com/IntegralEquation.html

There are also many good books. The following books describe many methods of solving integral equations with examples of practical applications:
1. Corduneanu, C., Integral Equations and Applications, Cambridge, England: Cambridge University Press, 1991.
2. Kondo, J., Integral Equations, Oxford, England: Clarendon Press, 1992.
3. Polyanin, A. D., and Manzhirov, A. V., Handbook of Integral Equations, Boca Raton, Fla.: CRC Press, 1998.
4. Delves, L. M., and Mohamed, J. L., Computational Methods for Integral Equations, Cambridge University Press, 1985.
5. Kanwal, R. P., Linear Integral Equations: Theory and Technique, (2^{nd} Ed.), Birkhauser Publishers, Boston, 1997.
   The Handbook by Polyanin and Manzhirov listed above is a comprehensive book with solution and useful information on over 2000 different types of integral equations. However it does not include the method of the present invention.

In the following patent application filed recently by the author of the present invention, a method for solving a particular type of integral equation is disclosed:
M. SubbaRao, “Methods and Apparatus for Computing the Input and Output Signals of a Linear Shift-Variant System”, Patent Application, Filed in USPTO on Sep. 26, 2005.
   The particular type of integral equation solved in the above application is called a “Linear Shift-Variant Integral (LSVI)” in the research literature of image and signal processing areas, and in the Mathematics and Physics literature, it is called “Fredholm Integral Equation of the First Kind (FIEFK)”. The method disclosed in the above application is based on the Rao Transform used here. However, the present invention is not restricted to just LSVI or FIEFK, but is applicable to a far greater class of equations, including linear/non-linear integral/integro-differential equations.

### 1.3 APPLICATIONS OF RT AND GRT

Rao Transform (RT) is useful in solving linear integral equations such as Fredholm and Volterra Integral Equations of the First and Second kind. General Rao Transform (GRT) is useful in solving non-linear integral equations such as Urysohn and Hammerstein Integral Equations of the First and Second kind. Together they provide a unified theoretical and computational framework. Fourier and Laplace transforms provide computationally efficient solutions to convolution integral equations. Similarly, RT and GRT provide computationally efficient solutions to general integral equations. RT and GRT can be naturally extended from the case of one-dimensional problems to multi-dimensional cases. The solution methods can also be extended to linear combinations of standard form integral/integro-differential equations, and simultaneous integral/integro-differential equations. In this patent application, although the terms RT and GRT are used as if they are single fixed transforms for the sake of simplicity, it will become clear by the end of this application that both RT and GRT are really a large class of transforms rather than single fixed transforms. For example, RT alone describes one different transform for each type of well-known integral equation such as Fredholm Integral Equation of the First/Second Kind, Volterra Integral Equation of the First/Second Kind, etc.

It is well-known that Ordinary Differential Equations (ODEs) can be converted to Volterra type Integral Equations of the Second Kind (see page 180, J. Kondo, Integral Equations, Oxford University Press, 1991, ISBN 0-19-859681-2). Therefore the method of the present invention can be used to solve ODEs. Another example of the application of Integral Equations is in solving Partial Differential Equations (PDEs) which can be reduced to Fredholm type integral equations. Also non-linear differential equations can be converted to non-linear integral equations which could be solved by the method of the present invention. Many problems in mathematical physics are expressed in terms of ODEs and PDEs. See Chapters 5 and 10 in the book by J. Kondo cited above for many examples. The method of the present invention can be useful in many of these applications.

### 1.4 OBJECTS

It is an object of the present invention to provide a method and associated apparatus for solving a large class of integral and integro-differential equations that are useful in practical applications. This class includes Fredholm Equations of the First and Second Kind, Volterra Equations of the First and Second Kind, linear combinations of these Fredholm and Volterra equations, and many non-linear equations.

It is another object of the present invention to provide a method and associated apparatus for computing the input given the output, and also for computing the output given the input, of a linear/non-linear integral/integro-differential system/process.

It is another object of the present invention to provide a method for solving integral and integro-differential equations using RT/GRT that is unified, computationally efficient, localized, non-iterative, and deterministic. The method uses explicit and closed form formulas and algorithms where available, and does not use any statistical or stochastic model of functions in the equations.

Another object of the present invention is a method of solving integral and integro-differential equations using local computations leading to efficiency, accuracy, stability, and the ability to be implemented on parallel computational hardware.

Another object of the present invention is a method and apparatus for solving multi-dimensional integral and integro-differential equations in a computationally efficient, non-iterative, and localized manner.

Another object of the present invention is a method for solving differential equations by first solving corresponding equivalent integral equations or integro-differential equations.

### 1.5 SUMMARY OF THE INVENTION

The present invention includes a method of solving an Integro-Differential Equation (IDE). An Integral Equation (IE) is a special case of an IDE and therefore the present invention is also relevant to integral equations. An IDE contains an integral term with an integrand dependent on an integration variable α, an independent variable x, a kernel function h′ which depends on both x and α, and an unknown function f which is dependent on a single variable. The method of the presnt invention comprises the following steps. A given IDE which needs to be solved is first expressed in a Rao-X Integro-Differential Equation (ROXIDE) form described later. In the ROXIDE form, the integrand becomes dependent on f(x−α) instead of f(α). This step is needed if the given IDE is not already in a ROXIDE form. Converting a general IDE to a ROXIDE form involves two steps. The first step is to find a localized kernel function h of the given kernel function h′ in the original IDE. This is accomplished using the General Rao Localization Transform (GRLT) described later. Then the integrand in the original IDE is expressed in terms of f(x−α) and the new localized kernel function h. If the integrand includes derivatives of f such as f⁽ⁿ⁾(α), they are replaced by f⁽ⁿ⁾(x−α). This expresses the integrand in the given IDE in a standard localized form of General Rao Transform (GRT). The new integral term along with other terms of the IDE is said to be in ROXIDE form. Although the new integral term has been expressed in terms of a new kernel h and f(x−α) instead of h′ and f(α), GRLT and GRT are defined such that the new integral term will be exactly equal and equivalent to the original integral term.

In the next step, the term f(x−α) (and f⁽ⁿ⁾(x−α) if any) in the new integrand are replaced with a truncated Taylor-series expansion around x up to an integer order N, and all higher order derivative terms of f are set to zero. The localized kernel function h, which depends on x−α and α, is also replaced with its truncated Taylor series expansion around the point x and α. After these two replacements or substitutions, the resulting new integral term is simplified by grouping terms based on the unknowns which are the derivatives of f with respect x at x denoted by f⁽ⁿ⁾ for an n-th order derivative. In this simplification step, the unknowns f⁽ⁿ⁾ are moved to be outside definite integrals that arise during simplification and grouping of terms. The resulting simplified equation serves as the basic equation for solving the original IDE. Interestingly, this simplified equation can also be used for solving another problem when the function f is already known or given. That problem is to efficiently compute the value of the integral term in the integral equation. This computation can be done efficiently using the simplified equation obtained at this step.

The simplified equation obtained in the above step is used to derive a system of at least N equations by taking various derivatives with respect to x of the simplified equation. In each equation obtained by taking a different order derivative with respect to x at x, higher order derivatives of f of order greater than N are all set to zero. In the resulting equations, all definite integrals are computed symbolically or numerically using the given value of x if needed. This results in a system of N or more equations. These equations are solved to obtain the unknown function f(x) (which is also denoted by f⁽⁰⁾). This function f(x) is the desired solution of the original IDE. It is also the solution of the equivalent ROXIDE. This function f(x) is provided as the solution in the method of the present invention.

A special case of the Integro-Differential Equation (IDE) above is when there are no terms with derivatives of the unknown function f outside the integral term. In this case, the IDE becomes a regular Integral Equation (IE). In this special case, the ROXIDE above becomes a simple Rao-X Integral Equation or ROXIE for short.

In this patent application, a large number of ROXIEs which can be solved by the method of the present invention are listed explicitly, such as, Fredholm/Volterrra Integral Equations of First/Second kind, etc.

The method of the present invention is applicable to the case where the variables α and x are multi-dimensional vectors. In particular, the present invention is applicable to one, two, three, and any integer dimensional variables α and x. The present invention deals with the case where α and x are real valued variables or vectors. The case of complex valued variables and vectors for α and x will be investigated in the future.

The method of the present invention can be used for solving both ordinary differential equations (ODEs) and partial differential equations (PDEs) by first reformulating or converting them (i.e. ODEs/PDEs) into corresponding integral equations. The solution of these equivalent integral equations can be obtained using the method of the present invention. This solution is used to provide a solution for the corresponding ODE/PDE.

The method of the present invention suggests an apparatus for solving an integro-differential equation. The different parts of the apparatus correspond to the different steps in the method of the present invention. This apparatus of the present invention includes:
1. A means for reading as input an integro-differential equation with integral terms;
2. A means for applying General Rao Localization Transform to integral terms to convert the integral terms to General Rao Transform form and derive an integro-differential equation in ROXIDE form;
3. A means for truncated Taylor-series substitution for f and h and simplification of mathematical expressions derived from ROXIDEs;
4. A means for computing the derivatives of ROXIDEs and solving resulting algebraic equations to obtain a solution f(x) for the integro-differential equation; and
5. A means for providing the solution f(x) of the integro-differential equation as output.

### 1.6 BRIEF DESCRIPTION OF THE DRAWINGS

FIG. 1 is a schematic diagram of a Linear Integral System showing the unknown function f(x), known function g(x), integration kernel h′(x,α) and the shift-variance and point spread dimensions. This system is modeled by a Linear Integral Equation which specifies the output g(x) in terms of the input f(x) and the integration kernel h′.

FIG. 2 shows a conventional method of modeling a linear integral system by an integral equation. This model does not exploit the locality property of kernels of integral systems.

FIG. 3 shows a novel method of modeling an integral system using the Rao Transform. This model fully exploits the locality property of the kernels of integral systems/equations.

FIG. 4 shows a model of a non-linear integral system/equation.

FIG. 5 shows a conventional method of modeling a non-linear integral system by a non-linear integral equation.

FIG. 6 shows a novel method of modeling a non-linear integral system/equation using the General Rao Transform.

FIG. 7 shows the method of the present invention for solving linear integro-differential equations.

FIG. 8 shows the method of the present invention for solving non-linear integro-differential equations.

FIG. 9 shows the Apparatus of the present invention for solving integro-differential equations.

FIG. 10 shows the method of the present invention for solving Ordinary Differential Equations (ODEs) and Partial Differential Equations (PDEs).

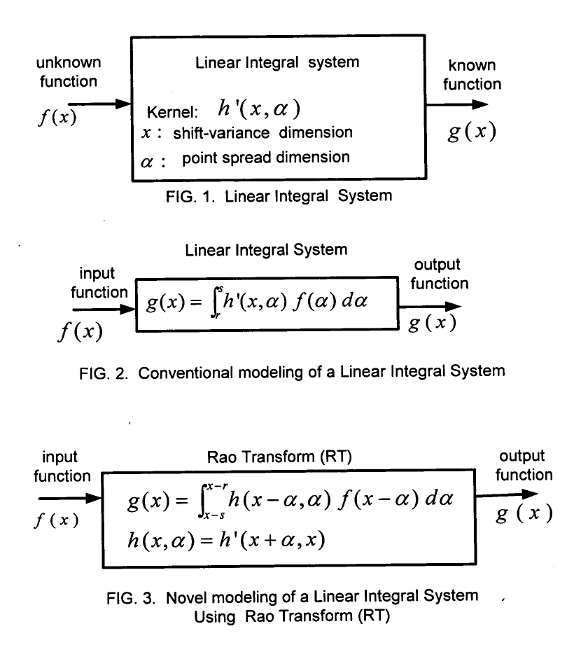

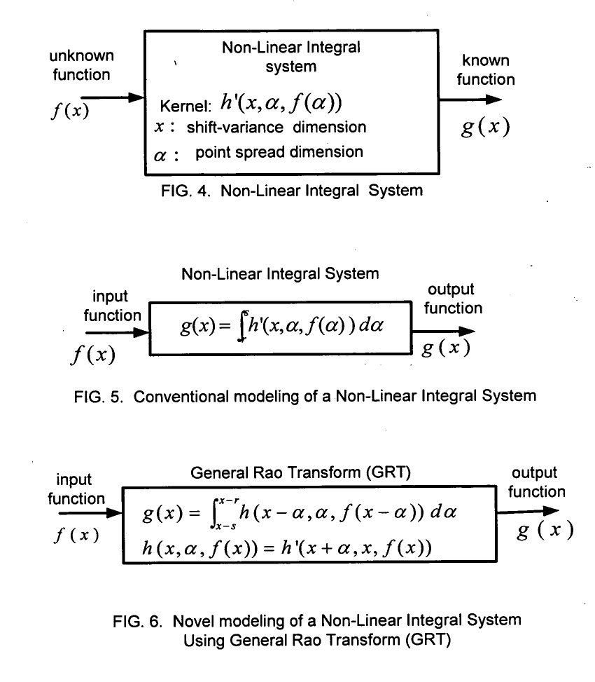

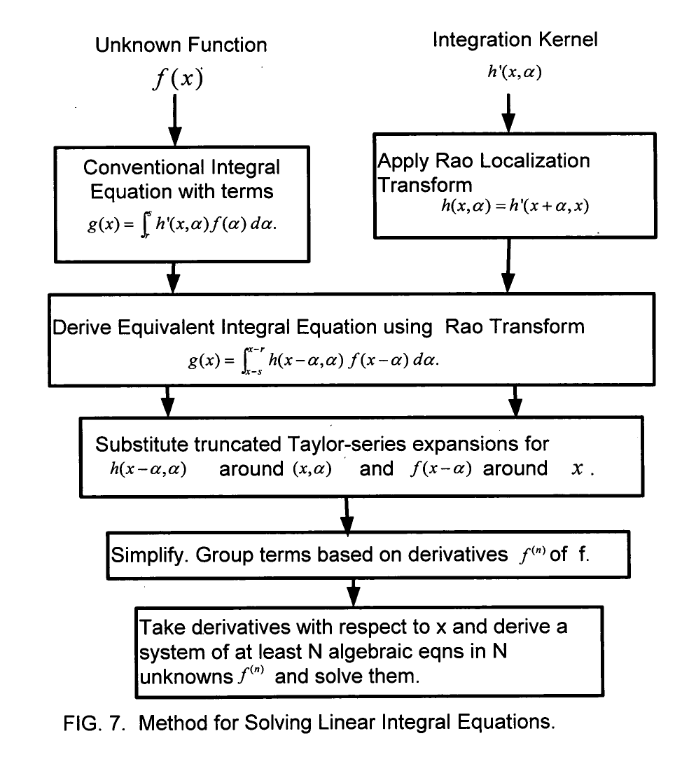

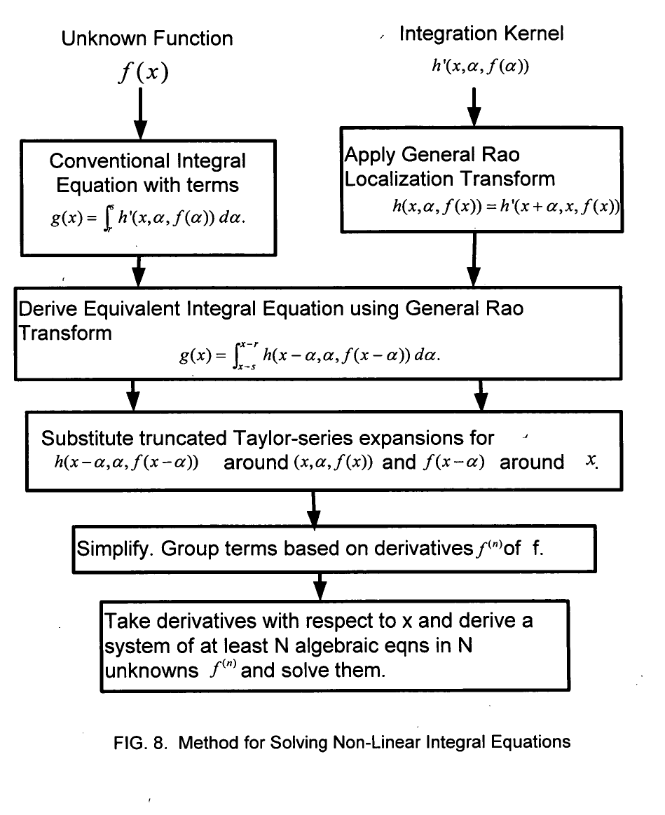

### 2.0 DETAILED DESCRIPTION

An integral or integro-differential equation includes at least one unknown real valued function f(x) where x is a real variable that will be referred to as a shift-variable due to its role in shift-variant image deblurring. The equation also includes, at least one known real valued function g(x), and at least one known real valued kernel function h(x,α) in a special case or in general h(x,α,f(α)) where α is a real variable referred to as a point spread variable due to its role in representing the point spread function of a shift-variant image blurring. The integral or integro-differential equations are solved using Rao Transform (RT) or General Rao Transform (GRT) described later. For simplifying the description of the method of the present invention, x and α are considered to be one-dimensional variables, but they can also be considered to be multi-dimensional variables.

2.1. Rao Transform, Integral Transform, and Rao Localization Transform

Rao Transform(RT) is defined as
g(x)=∫ₓ₋ₛ^{x-r}h(x−α,α)f(x−α)dα(RT) (2.1.1)
where x and α are real variables, f(x) is an unknown real valued function that we need to solve for, g(x) and h(x,α) are known (or given) real valued functions. r and s may be real constants or one of them can be the real variable x. All functions here are assumed to be continuous, integrable, and differentiable. h(x,α) is referred to as the kernel function or point spread function (psf). x will be referred to as the shift-variable due to its role in shift-variant image blurring and a will be referred to as the point spread variable or just spread variable. g(x) is referred to as the Rao Transform of f(x) with respect to the transform kernel h(x,α). The above equation is reffered to as the Rao Integral Equation and the right hand side of the equation is referred to as the Rao Integral While this definition is for real valued functions and variables, its extension to complex variables and functions is currently under investigation.

The above definition of Rao Transform should be compared to the conventional Integral Transform (IT) defined as:
g(x)=∫ᵣ^{s}h′(x,α)f(α)dα. (IT) (2.1.2)
In the above equation the kernel is denoted by h′ (note the prime) to distinguish it from the kernel h in RT, and the limits of integration are changed to r and s.

One of the key novel ideas here is that the conventional integral equation above (Eq. 2.1.2) can be transformed to an exactly equivalent Rao Integral Equation (Eq. 2.1.1). This is done by a suitable refunctionalization and reparameterization of the appropriate functions and parameters as needed. Such a transformation is accomplished through the Rao Localization Transform (RLT). Applying RLT helps to localize the problem of solving the equation at a point x in a sense that the parameters of the unknown function f are restricted to the derivatives of f at the same point x.

RLT defines the relation between h and h′ in Equations (2.1.1) and (2.1.2) so that the two equations become exactly equivalent. Given one of these equations, the other equation can be obtained using RLT. The relation between the kernel h in RT and h′ in IT is shown to be the following in Section 5:
h(x,α)=h′(x+α,x) and (RLT) (2.1.3)
h′(x,α)=h(α,x−α) (IRLT) (2.1.4).
The above equations are very useful in converting Equation (2.1.2) to Eq. (2.1.1) and vice versa. Equation (2.1.3) will be referred to as the Rao Localization Transform (RLT) and Eq. (2.1.4) will be referred to as the Inverse Rao Localization Transform (IRLT). Note that RT is a linear integral transform. Next we consider non-linear integral equations.
2.2. General Rao Transform, General Integral Transform, General Rao Localization Transform

One example of a General Rao Transform (GRT) is given by:
g(x)=∫ₓ₋ₛ^{x-r}h(x−α,α,f(x−α))dα. (GRT) (2.2.1)
In the above equation, r and s may be constants or one of them can be the variable x. Also, the kernel h depends on f(x). g(x) is referred to as the General Rao Transform (GRT) of f(x) with respect to the transform kernel h. More general examples of GRT will be used later. The above transform should be compared with a conventional General Integral Transform (GIT) defined as:
g(x)=∫ᵣ^{s}h′(x,α,f(α))dα. (GIT) (2.2.2)
In the above equation the kernel is denoted by h′ (note the prime) to distinguish it from h and the limits of integration are changed to r and s. A given integral equation as above can be transformed into another exactly equivalent integral equation of the GRT form using the General Rao Localization Transform (GRLT).

GRLT helps to localize the problem of solving the equation at a point x in a sense that the parameters of the unknown function f are restricted to the derivatives of f at the same point x. GRLT defines the relation between h and h′ in Equations (2.2.1) and (2.2.2) so that the two equations become equivalent. Given one of these equations, the other equation can be obtained using GRLT. The relation between the kernel h in GRT and h′ in GIT are shown to be the following in Section 5:
h(x,α,f(x))=h′(x+,x,f(x)) (GRLT) (2.2.3)
h′(x,α,f(α))=h(α,x−α,f(α)) (IGRLT) (2.2.4)
The above equations are very useful in converting Equation (2.2.2) to Eq. (2.2.1) and vice versa. Equation (2.2.3) will be referred to as the General Rao Localization Transform (GRLT) and Eq. (2.2.4) will be referred to as the Inverse General Rao Localization Transform (IGRLT). Note that Rao Transform (RT) is a special case of General Rao Transform (GRT) where
h(x−α,α,f(x−α))=h₁(x−α,α)f(x−α). (2.2.5)

GRT can be further generalized to handle even more complex kernel functions. Some such examples are presented later. In each case, a suitable Rao localization transform is defined to transform a conventional integral equation to the equivalent Rao integral equation. Since the kernel function will be known, this is always possible. In this patent application, the name General Rao Transform (GRT) and General Rao Localization Transform (GRLT) encompass all such possible generalizations of GRT and GRLT. Similarly, the inverse of these generalizations are encompassed by the names IGRT and IGRLT.

The idea of refunctionalization (e.g. changing h′ to h) and reparameterization (e.g. x to x′) may have applications in solving equation types other than integral equations. This idea will be explored in the future.

RT and GRT can be used to solve many types of integral and integro-differential equations after converting them to RT/GRT using RLT/GRLT. When an integral/integro-differential equation of some type X is converted to RT/GRT form using RLT/GRLT, the resulting equation is said to be a Rao-X integral/integro-differential Equation or ROXIE/ROXIDE for short. Some examples of Rao-X integral equations are listed below. Additional examples are included later.

2.3 Rao-X Integral Equations (ROXIES)

2.3.1 Fredholm Integral Equation of the First Kind

Rao-X Integral Equation (ROXIE) in this case is defined as
g(x)=∫_{x-b}^{x-a}h(x−α,α)f(x−α)dα, (RF1) (2.3.1.1)
where a and b are constants here, and in the rest of this report. This can be used to solve the standard Fredholm Integral Equation of the First Kind (F1):
g(x)=∫ₐ^{b}h′(x,α)f(α)dα (F1) (2.3.1.1).
2.3.2 Fredholm Integral Equation of the Second Kind

ROXIE in this case is defined as
g(x)=f(x)+∫_{x-b}^{x-a}h(x−α,α)f(x−α)dα. (RF2) (2.3.2.1)
This can be used to solve the standard Fredholm Integral Equation of the Second Kind (F2) using RLT:
g(x)=f(x)+∫ₐ^{b}h′(x,α)f(α)dα. (F2) (2.3.2.2)
2.3.3 Volterra Integral Equation of the First Kind

ROXIE in this case is
g(x)=∫₀^{x-a}h(x−α,α)f(x−α)dα, (RV1) (2.3.3.1)
This can be used to solve the standard Volterra Integral Equation of the First Kind (V1):
g(x)=∫ₐ^{x}h′(x,α)f(α)dα (V1) (2.3.3.2).
2.3.4 Volterra Integral Equation of the Second Kind

ROXIE in this case is
g(x)=f(x)+∫₀^{x-a}h(x−α,α)f(x−α)dα, (RV2) (2.3.4.1)
This can be used to solve the standard Volterra Integral Equation of the Second Kind (V2):
g(x)=f(x)+∫ₐ^{x}h′(x,α)f(α)dα (V2) (2.3.4.2).
2.3.5 Urysohn Integral Equation of the First Kind

ROXIE in this case is
g(x)=∫_{x-b}^{x-a}h(x−α,α,f(x−α))dα, (RU1) (2.3.5.1)
This can be used to solve the Urysohn Integral Equation of the First Kind (U1):
g(x)=∫ₐ^{b}h′(x,α,f(α))dα (U1) (2.3.5.2).
The relation between the kernel h in RU1 and h′ in U1 is given by GRLT and IGRLT.
2.3.6 Urysohn Integral Equation of the Second Kind

ROXIE in this case is
g(x)=f(x)+∫_{x-b}^{x-a}h(x−α,α,f(x−α))dα, (RU2) (2.3.6.1)
This can be used to solve the Urysohn Integral Equation of the Second Kind (U2):
g(x)=f(x)+∫ₐ^{b}h′(x,α,f(α))dα (U2) (2.3.6.2).
2.3.7 Urysohn-Volterra Integral Equation of the First Kind

ROXIE in this case is
g(x)=∫₀^{x-a}h(x−α,α,f(x−α))dα, (RUV1) (2.3.7.1)
This can be used to solve the Urysohn-Volterra Integral Equation of the First Kind (UV1):
g(x)=∫ₐ^{x}h′(x,α,f(α))dα (UV1) (2.3.7.2).
2.3.8 Urysohn-Volterra Integral Equation of the Second Kind

ROXIE in this case is
g(x)=f(x)+∫₀^{x-a}h(x−α,α,f(x−α))dα, (RUV2) (2.3.8.1)
This can be used to solve the Urysohn-Volterra Integral Equation of the Second Kind (UV2):
g(x)=f(x)+∫ₐ^{x}h′(x,α,f(α))dα (UV2) (2.3.8.2).

More examples of equations that can be solved are given later. Given a standard conventional integral equation of type X, it is converted to a new equivalent integral equation of type Rao-X (ROXIE) using the RLT/GRLT. A detailed method of solving a ROXIE is described in the next section.

### 3. UNIFIED ALGORITHMS FOR SOLVING INTEGRAL AND INTEGRO-DIFFERENTIAL EQUATIONS

3.1 Method of Solving Linear Rao-X Integral Equations (ROXIEs):

If the given equation to be solved is a differential equation, it is converted to an integral or an integro-differential equation using one of the standard methods. Such methods can be found in many classical text books on integral equations including—
J. Kondo, Integral Equations, Oxford University Press, 1991, ISBN 0-19-859681-2.
   The method of present invention includes the following steps.

3.1.1 Given a conventional integral or integro-differential equation with an unknown function f and at least one kernel h′, derive an equivalent integral/integro-differential equation that is in one of the standard Rao-X integral/integro-differential Equation form as follows:
a. Find the localized form of each kernel function in the equation using, if necessary, the Rao Localization Transform or General Rao Localization transform.
b. Express all integral terms in the equation in the form of Rao Transform or General Rao Transform.

For example, let the given integral equation be a modified Volterra Integral Equation of the Second Kind (MV2) where f(x) is replaced by a linear constant coefficient differential operator applied to f(x):

$$g ( x ) = {\sum }_{n = 0}^{N} {c}_{n} {f}^{( n )} ( x ) + {\int }_{a}^{x} {h}^{′} ( x , α ) f ( α ) ⅆ α \qquad ( MV2 ) \qquad ( 3.1 .1 .1 )$$

where cₙ are real constants and f⁽ⁿ⁾ is the n-th derivative of f(x) at x with respect to x defined by

$${f}^{( n )} = {f}^{( n )} ( x ) = \frac{{ⅆ}^{n} f ( x )}{ⅆ {x}^{n}} . \qquad ( 3.1 .1 .2 )$$

In the above equation, g(x), h′(x,α), x, and α, are all given. The problem is to solve for f(x). Here, the given problem is not localized as the kernel h′(x,α) is multiplied with f(α) and integration is carried-out with respect to a which changes from point to point during the integration or summation operation. Therefore, we localize the problem using the Rao Localization Transform to get
h(x,α)=h′(x+α,x) (RLT) (3.1.1.3)

Next we write a reformulated but equivalent integral equation which is a modified Rao-Volterra Integral Equation of the Second Kind (MRV2):

$$g ( x ) = {\sum }_{n = 0}^{N} {c}_{n} {f}^{( n )} ( x ) + {\int }_{0}^{x - a} h ( x - α , α ) f ( x - α ) ⅆ α . \qquad ( MRV2 ) \qquad ( 3.1 .1 .4 )$$

In this reformulated equation, the unknown function can be parameterized in terms of localized parameters that do not change during the integration operation. This will be clarified in the next step.

3.1.2 Replace each term of the unknown function of the form f(x−α) with a truncated Taylor-series expansion of f(x−α) around x. Also, replace each term of the derivative of the unknown function of the form f^{(k)}(x−α) with a truncated Taylor-series expansion of f^{(k)}(x−α) around x. All derivatives of f of order greater than N are taken to be zero, i.e. f^{(k)}(x)=0 for k>N. The value of N can be increased arbitrarily to obtain desired accuracy. In the subsequent steps, assume that all other derivatives of f that do not appear in the truncated Taylor series to be zero.

In the example of MRV2, the Taylor series expansion of f(x−α) around the point x up to order N is

$$\begin{matrix}f ( x - α ) = {\sum }_{n = 0}^{N} {a}_{n} {α}^{n} {f}^{( n )} ( x ) \\ where & ( 3.1 .2 .1 ) \\ {a}_{n} = \frac{{( - 1 )}^{n}}{n !} & ( 3.1 .2 .2 )\end{matrix}$$

and f⁽ⁿ⁾ is the n-th derivative of f defined in Eq. (3.1.1.2).

The above equation is exact and free of any approximation error when f is a polynomial of degree less than or equal to N. In this case, the derivatives of f of order greater than N are all zero. When f has non-zero derivatives of order greater than N, then the above equation will have an approximation error corresponding to the residual term of the Taylor series expansion. This approximation error usually converges rapidly to zero as N increases. In the limit as N tends to infinity, the above series expansion becomes exact and complete. Note that the derivatives f⁽ⁿ⁾ do not depend on α. They depend only on x which is the property that makes the new equation localized. These derivatives will be used to characterize and parameterize f in a small interval around x.

3.1.3 Replace each kernel term of the form h(x−α,α) or h(x−α,α,f(x−α)) with its Taylor series expansion around the point (x,α) or (x,α,f(x)) respectively. If necessary, truncate this Taylor-series.

In the example of MRV2, the Taylor series expansion of h(x−α,α) around the point (x,α) up to order M is

$$\begin{matrix}h ( x - α , α ) = {\sum }_{m = 0}^{M} {a}_{m} {α}^{m} {h}^{( m )} ( x , α ) \\ where & ( 3.1 .3 .1 ) \\ {a}_{m} = \frac{{( - 1 )}^{m}}{m !} . \\ and & ( 3.1 .3 .2 ) \\ {h}^{( m )} = {h}^{( m )} ( x , α ) = \frac{{\partial }^{m} h ( x , α )}{\partial {x}^{m}} . & ( 3.1 .3 .3 )\end{matrix}$$

Due to the locality property explained in the next paragraph, the Taylor series above converges rapidly as M increases, and in the limit as M tends to infinity, the error becomes zero and the series expansion becomes exact and complete.

In many practical and physical systems, most of the “energy” of a kernel h is localized or concentrated in a small region or interval bounded by |α|<T for all x where T is a small constant. This energy content is defined by
E(x,T)=∫_{-T}^{T}|h(x−α,α)|α. (3.1.3.4)

This property of physical systems will be called the locality property since the energy spread of the kernel is localized and distributed in a small region close to the point (x,0). In mathematics literature, this property is sometimes stated by saying that the kernel h is a compact kernel or that h has compact support.

Now the integral equation of the example becomes

$$g ( x ) = {\sum }_{n = 0}^{N} {c}_{n} {f}^{( n )} ( x ) + {\int }_{0}^{x - a} [ {\sum }_{m = 0}^{M} {a}_{m} {α}^{m} {h}^{( m )} ] [ {\sum }_{n = 0}^{N} {a}_{n} {α}^{n} {f}^{( n )} ] ⅆ α \qquad ( 3.1 .3 .5 )$$

Simplify the resulting expression by grouping terms based on the unknowns f⁽ⁿ⁾. In particular, move the unknowns f⁽ⁿ⁾ to be outside the definite integrals.

In the MRV2 example, rearranging terms and changing the order of integration and summation, we get

$$g ( x ) = {\sum }_{n = 0}^{N} {c}_{n} {f}^{( n )} ( x ) + {\sum }_{n = 0}^{N} {a}_{n} {f}^{( n )} [ {\sum }_{m = 0}^{M} {a}_{m} {\int }_{0}^{x - a} {( α )}^{m + n} {h}^{( m )} ( x , α ) ⅆ α ] \qquad ( 3.1 .4 .1 )$$

Note that the unknown parameters f⁽ⁿ⁾ are outside the integral. They can be taken outside the integral because they do not depend on the variable of integration, which in this case is α. They depend only on x which is the point at which the solution for the equation is being sought. In this sense, the problem is now localized. Therefore, the reformulated equation is now much simpler to solve than the original equation. Also, for compact kernels with highly localized or concentrated energy distribution with respect to α, the right hand side converges rapidly for even small values of M.

Now, define the n-th partial moment of the m-th derivative of the kernel h to be

$${h}_{n}^{( m )} = {h}_{n}^{( m )} ( x ) = {\int }_{0}^{x - a} {α}^{n} \frac{{\partial }^{m} h ( x , α )}{\partial {x}^{m}} ⅆ α . \qquad ( 3.1 .4 .2 )$$

Using the above definition, the integro-differential equation becomes

$$g ( x ) = {\sum }_{n = 0}^{N} {c}_{n} {f}^{( n )} + {\sum }_{n = 0}^{N} {a}_{n} {f}^{( n )} [ {\sum }_{m = 0}^{M} {a}_{m} {h}_{m + n}^{( m )} ] . \qquad ( 3.1 .4 .3 )$$

This can be rewritten as

$$\begin{matrix}g ( x ) = {\sum }_{n = 0}^{N} {S}_{n} {f}^{( n )} , \\ where {S}_{n} is & ( 3.1 .4 .4 ) \\ {S}_{n} = {c}_{n} + {a}_{n} {\sum }_{m = 0}^{M} {a}_{m} {h}_{m + n}^{( m )} . & ( 3.1 .4 .5 )\end{matrix}$$

Note that, Equation (3.1.4.4) above provides an efficient method for evaluating g(x) provided f(x) is given. This equation is useful in computing the output g(x) of an integral/integro-differential system given its input f(x) and given the kernel h or h′ that uniquely characterizes the system.

3.2 Derive a system of at least N equations by taking various derivatives with respect to x of the equation derived in Step 3.1.3. Set to zero any derivatives of f that do not appear in the truncated Taylor series in Step 3.1.2. In particular, set derivatives of f of order larger than N to be zero, i.e. f^{(k)}(x)=0 for k>N. Compute symbolically or numerically, all definite integrals (the value of x is assumed to be given). These integrals typically correspond to full or partial moments of derivatives of the kernel h.

This step results in a set of linear algebraic equations in the case of RF1, RF2, RV1, and RV2, and similar linear integral/integro-differential equations. It results in non-linear algebraic (polynomial) equations in the case of RF3, RF4, RV3, and RV4 and similar non-linear integral/integro-differential equations.

In the example under consideration, following the above step, the k-th derivative of g(x) with respect to x is given by

$${g}^{( k )} ( x ) = {\sum }_{p = 0}^{k} {C}_{p}^{k} {\sum }_{n = 0}^{N - p} {f}^{( n + p )} {S}_{n}^{( k - p )} \qquad ( 3.1 .5 .1 )$$

where Cₚ^{k} is the binomial coefficient

$$\begin{matrix}{C}_{p}^{k} = \frac{k !}{p ! ( k - p ) !} \\ and & ( 3.1 .5 .2 ) \\ {S}_{n}^{( k - p )} = {a}_{n} {\sum }_{m = 0}^{M - k + p} {a}_{m} {h}_{m + n}^{( m + k - p )} + {c}_{n}^{′} , & ( 3.1 .5 .3 )\end{matrix}$$

where cₙ′=0 if k>p and cₙ′=cₙ if k=p. Note that, in the above derivation, derivatives of f higher than N-th order and derivatives of h higher than M-th order are approximated to be negligible or zero. Note also that, although x appears as a limit of a definite integral and also within the integrand, there is no problem in computing the term hₘ₊ₙ^{(m+k-p)}. For example,

$$\begin{matrix}\frac{ⅆ {h}_{n}^{( m )}}{ⅆ x} = \frac{ⅆ {h}_{n}^{( m )} ( x )}{ⅆ x} = \frac{ⅆ}{ⅆ x} {\int }_{0}^{x - a} {α}^{n} \frac{{\partial }^{m} h ( x , α )}{\partial {x}^{m}} ⅆ α . & ( 3.1 .5 .4 ) \\ = {( x - a )}^{n} \frac{{\partial }^{m} h ( x , x - α )}{\partial {x}^{m}} + {\int }_{0}^{x - a} {α}^{n} \frac{{\partial }^{m + 1} h ( x , α )}{\partial {x}^{m + 1}} ⅆ α = {( x - a )}^{n} {h}^{( m )} ( x , x - a ) + {h}_{n}^{( m + 1 )} & ( 3.1 .5 .5 )\end{matrix}$$

In equation (3.1.5.1), the only unknowns are—−f(x) which is the same as the zero-th order derivative of f denoted by f⁽⁰⁾, and its N derivatives—f⁽¹⁾, f⁽²⁾, . . . ,f⁽ⁿ⁾. We can solve for all these unknowns using the following method.

3.3 Solve the resulting algebraic equations to obtain all the unknowns. In particular, f⁽⁰⁾ gives the desired solution.

In the example, consider the sequence of equations obtained by writing Equation (3.1.5.1) for k=0,1,2, . . . , N, in that order. We have here, N+1 linear equations in the N+7 unknowns f⁽⁰⁾,f⁽¹⁾,f⁽²⁾, . . . ,f⁽ⁿ⁾. Given all the other parameters, we can solve these equations either numerically or algebraically to obtain all the unknowns, and f⁽⁰⁾ in particular. In the case of numerical solution, we will have to solve a linear system of N+1 equations. In practical applications N is usually small, between 2 to 6. Therefore, at every point x where the function f(x) needs to be computed, we will need to compute the N derivatives g^{(k)} given g, and invert an N+1×N+1 matrix. We will also need to compute the coefficients Sₙ^{(k-p)} which may involve numerical integration of the kernel h. In Equation (3.1.5.1), we can regroup the terms and express it as

$${g}^{( k )} = {\sum }_{n = 0}^{N} {S}_{k , n} {f}^{( n )} \qquad ( 3.1 .5 .6 )$$

for k=0,1,2, . . . , N. The above equation can also be written in matrix form as
g=Sf (3.1.5.7)
where g=[g⁽⁰⁾, g⁽¹⁾, . . . , g^{(N)}]^{t} and f=[f⁽⁰⁾, f⁽¹⁾, . . . , f^{(N)}]^{t} are (N+1)×1 column vectors and S is an (N+1)×(N+1) matrix whose element in the k-th row and n-th column is S_{k,n} for k,n=0,1,2, . . . , N.

Symbolic or algebraic solutions (as opposed to numerical solutions) to the above equations for g would be useful in theoretical analyses. These equations can be solved symbolically by using one equation to express an unknown in terms of the other unknowns, and substituting the resulting expression into the other equations to eliminate the unknown. Thus, both the number of unknowns and the number of equations are reduced by one. Repeating this unknown variable elimination process on the remaining equations systematically in sequence, the solution for the last unknown will be obtained. Then we proceed in reverse order of the equations derived thus far, and back substitute the available solutions in the sequence of equations to solve for the other unknowns one at a time, until we obtain an explicit solution for all unknowns, and f⁽⁰⁾ in particular. This approach is described in more detail below.

The first equation for k=0 can be used to solve for f⁽⁰⁾ in terms of g⁽⁰⁾ and f⁽¹⁾, f⁽²⁾, . . . ,f^{(N)}. The resulting expression can be substituted in the equations for g^{(k)} for k=1, 2, . . . , N, to eliminate f⁽⁰⁾ in those equations. Now we can use the expression for g⁽¹⁾ to solve for f⁽¹⁾ in terms of g⁽⁰⁾, g⁽¹⁾, and f⁽²⁾, f⁽³⁾, . . . ,f^{(N)}. The resulting expression for f⁽¹⁾ can be used to eliminate it from the equations for g⁽²⁾, g⁽³⁾, . . . , g^{(N)}. Proceeding in this manner, we obtain an explicit solution for f^{(N)} in terms of g⁽⁰⁾, g⁽¹⁾, . . . , g^{(N)}. Then we back substitute this solution in the previous equation to solve for f^{(N-1)}. Then, based on the solutions for f^{(N)} and f^{(N-1)} we solve for f^{(N-2)} in the next previous equation, and proceed similarly, until we solve for f⁽⁰⁾.

In matrix form, the solution for f can be written as
f=S′g (3.1.5.8)
where S′ is the inverse (obtained by matrix inversion) of S. This form of the solution is useful in a numerical implementation. The size of the matrix S′ is (N+1)×(N+1). An element of this matrix in the k-th row and n-th column will be denoted by S′_{k,n} for k,n=0,1,2, . . . , N. In algebraic form, we can write the solution for f as

$${f}^{( k )} = {\sum }_{n = 0}^{N} {S}_{k , n}^{′} {g}^{( n )} \qquad ( 3.1 .5 .9 )$$

The above equation is adequate in all practical applications for obtaining f given g and h. In the limiting case when N and M both tend to infinity, the above inversion becomes exact. When we set k=0 in the above equation, we get the desired solution as:

$$f ( x ) = {f}^{( 0 )} = {\sum }_{n = 0}^{N} {S}_{n}^{′} {g}^{( n )} \qquad ( 3.1 .5 .10 )$$

where S′ₙ=S′_{0,n}. From a theoretical point of view, it is of interest to note that the solution could be very likely written in an integral form:
f(x)=∫₀^{x-a}h″(x−α,α)g(x−α)dα (3.1.5.11)
where h″(x−α,α) is in some sense an inverting kernel corresponding to S′. In the limiting case when M and N tend to infinity, it should be possible to determine the inverse kernel uniquely. However, in practical applications, M and N will be limited to small values. In this case, h″ may not be unique. Determining h″ is not necessary in practical applications, but it would be of theoretical interest. This problem will be investigated in the future.

Note that the solution of the integral equation includes not only f(x), but also its N derivatives. Therefore, if f(x) is a polynomial of degree less than N, then f(x) can be computed for all values of x using the derivatives. It provides a complete solution. However, even if f(x) is not a polynomial, but if a polynomial of order N approximates f(x) sufficiently well in a small interval around x, then f(x) can be estimated everywhere in that interval using the solution for the N derivatives of f(x). Therefore, this method provides a solution in a small interval or region around the point x.

### 4. METHOD OF SOLVING NON-LINEAR RAO-X INTEGRO-DIFFERENTIAL EQUATIONS (ROXIDEs)

Linear integro-differential equations considered so far are a special case of Non-Linear integro-differential equations. Now consider an example of a general non-linear integro-differential equation of the following type:
z(g(x),f⁽⁰⁾(x),f⁽¹⁾(x),f⁽²⁾(x), . . . ,f^{(N)}(x))=∫ₐ^{x}h′(x,α,f(α))dα (RVID) (4.1).
where z is some continuous differentiable function. Using the General Rao Localization Transform (GRLT), define a new kernel function h such that
h(x−α,α,f(x−α))=h′(x,α,f(α)) (4.2)
as:
h(x,α,f(x))=h′(x+α,x,f(x)). (4.3)
Using the new kernel function h, obtain the following equivalent integro-differential equation which is in the form of the General Rao Transform defined earlier. The resulting equation is the ROXIDE corresponding to the Volterra Integro-Differential Equation (RVID) mentioned earlier:
z(g(x), f⁽⁰⁾(x),f⁽¹⁾(x),f⁽²⁾(x), . . . ,f^{(N)}(x))=∫₀^{x-a}h(x−α,α,f(x−α))dα. (RVID) (4.4)

Now substitute a truncated Taylor-series expansion of f(x−α) around the point x up to order N as in Eq. (3.1.2.1) on the right hand side of the above equation. Taking some liberty with the notation of the function h, the resulting equation can be written as:

$$z ( g ( x ) , {f}^{( 0 )} ( x ) , {f}^{( 1 )} ( x ) , {f}^{( 2 )} ( x ) , ⋯ , {f}^{( N )} ( x ) ) = {\int }_{0}^{x - a} h ( x - α , α , {f}^{( 0 )} ( x ) , {f}^{( 1 )} ( x ) , {f}^{( 2 )} ( x ) , ⋯ , {f}^{( N )} ( x ) ) ⅆ α . \qquad ( 4.5 )$$

Now we substitute for h on the right hand side a truncated Taylor-series expansion of h(x−α,α,f⁽⁰⁾(x),f⁽¹⁾(x),f⁽²⁾(x), . . . ,f^{(N)}(x)) around the point h(x,α,f⁽⁰⁾(x), f⁽¹⁾(x), f⁽²⁾(x), . . . , f^{(N)}(x)) to obtain

$$h ( x - α , α , {f}^{( 0 )} ( x ) , {f}^{( 1 )} ( x ) , {f}^{( 2 )} ( x ) , ⋯ , {f}^{( N )} ( x ) ) = {\sum }_{m = 0}^{M} {a}_{m} {α}^{m} {h}^{( m )} ( x , α , {f}^{( 0 )} ( x ) , {f}^{( 1 )} ( x ) , {f}^{( 2 )} ( x ) , ⋯ , {f}^{( N )} ( x ) ) \qquad ( 4.6 )$$

where aₘ and h^{(m)} are as defined in Eq. (3.1.3.2) and Eq. (3.1.3.3) respectively. In the above equation, when computing the derivatives of h with respect x, i.e. when computing h^{(m)}, all derivatives of f of order higher than N are taken to be zero, i.e.
f^{(k)}(x)=0 for k>N. (4.7)

Now Equation (4.5) can be written as

$$z ( g ( x ) , {f}^{( 0 )} ( x ) , {f}^{( 1 )} ( x ) , {f}^{( 2 )} ( x ) , ⋯ , {f}^{( N )} ( x ) ) = {\sum }_{m = 0}^{M} {a}_{m} {\int }_{0}^{x - a} {α}^{m} {h}^{( m )} ( x , α , {f}^{( 0 )} ( x ) , {f}^{( 1 )} ( x ) , {f}^{( 2 )} ( x ) , ⋯ , {f}^{( N )} ( x ) ) ⅆ α \qquad ( 4.8 )$$

In the above equation, f⁽⁰⁾(x),f⁽¹⁾(x),f⁽²⁾(x), . . . , f^{(N)}(x), are the N unknowns. We can solve for these by deriving a system of N or more equations by taking derivatives of the above equation with respect to x. Once again, we use Eq. (4.7) to simplify the resulting equations. The system of equations can be written as

$$\frac{{\partial }^{k}}{\partial {x}^{k}} z ( g ( x ) , {f}^{( 0 )} ( x ) , {f}^{( 1 )} ( x ) , {f}^{( 2 )} ( x ) , ⋯ , {f}^{( N )} ( x ) ) = {\sum }_{m = 0}^{M} {a}_{m} \frac{{\partial }^{k}}{\partial {x}^{k}} {\int }_{0}^{x - a} {α}^{m} {h}^{( m )} ( x , α , {f}^{( 0 )} ( x ) , {f}^{( 1 )} ( x ) , {f}^{( 2 )} ( x ) , ⋯ , {f}^{( N )} ( x ) ) ⅆ α \qquad ( 4.9 )$$

for k=0,1,2,3, . . . , N′, where N′≧N.
The above system of equations are typically non-linear algebraic equations. They can be solved efficiently using one of the many numerical techniques such as gradient descent technique where the partial derivatives with respect to the unknowns f^{(k)}(x) are considered.

### 5. DERIVATION OF RLT, IRLT, GRLT, AND IGRLT

We use an algebraic approach to derive GRLT, and IGRLT. This derivation subsumes the derivation of RLT and IRLT since they are special cases of GRLT and IGRLT respectively.

A3. General Localization Theorem (GRLT Theorem):

Theorem: Let the General Integral Transform (GIT) be defined as
g₁(x)=∫ᵣ^{s}h′(x,α,f(α))dα, (GIT) (A3.1)
the corresponding General Rao Transform (GRT) be defined as
g₂(x)=∫ₓ₋ₛ^{x-r}h(x−α′,α′,f(x−α′))dα′, (GRT) (A3.2)
and define
α′=x−α (IGRLT reparameterization). (A3.3)
Also define
h′(x,α,f(α))=h(α,x−α,f(α)) (IGRLT refunctionalization). (A3.4)
Then,
h′(x,α,f(α))=h(x−α′,α′,f(x−α′)) (A3.5)
and
g₁(x)=g₂(x). (A3.6)
Further,
h(x,α,f(x))=h′(x+α,x,f(x)) (A3.7)
Proof: Consider the left hand side (LHS) of (A3.5):

$$\begin{matrix}{h}^{′} ( x , α , f ( α ) ) = h ( α , x - α , f ( α ) ) from ( A3 .4 ) \\ = h ( x - ( x - α ) , ( x - α ) , f ( x - ( x - α ) ) ) \\ = h ( x - {α}^{′} , {α}^{′} , f ( x - {α}^{′} ) ) from ( A3 .3 ) \\ = RHS of ( A3 .5 )\end{matrix}$$

Given (A3.5) and (A3.3), we have
α′=x−αdα′=−dα and (A3.8)
α=rα′=x−r and α=sα′=x−s (A3.9).
Therefore, from (A3.5), (A3.8), and (A3.9), we get (A3.6). Thus we have proved the equivalence of GRT and GIT.
In order to prove (A3.7), in (A3.4) set
x′=α, and α′=x−α, and note x=α+α′=x′+α′
   to get
   h′(x′+α′,x′,f(x′))=h(x′,α′,f(x′)) (A3.10)
   which proves (A3.7).

A similar approach as above can be used to prove more general localization theorems for other more general integral/integro-differential equations.

### 6. ADDITIONAL INTEGRAL/INTEGRO-DIFFERENTIAL EQUATIONS WHICH CAN BE SOLVED USING RT/GRT

A conventional integral/integro-differential equation of type X for any X can be converted to an equivalent integral/integro-differential equation using the RLT or GRLT. For any X, the resulting equation is referred to as Rao-X integral/integro-differential equation or ROXIE. For example, X may be one of Fredholm, Volterra, Urysohn, Hammerstein, etc. A list of Rao-X type equations which can be solved by RT/GRT is given in Section 2.3 and that list is continued here.

B1. Multi-dimensional Fredholm-Volterra Integral Equations Integral equations such as RF1,RF2,RU1,RU2, RV1,RV2,RUV1, and RUV2, where the variables x and α are 2, or 3, or multi-dimensional (more than 3) vectors or variables.

B2. Linear Combinations of Fredholm-Volterra Integral Equations (RF1,RF2,RU1,RU2, and RV1,RV2,RUV1,RUV2), where the functions f, g, and h, remain the same in all equations.

B3. Linear Combinations of Fredholm-Volterra Integral Equations (RF1,RF2,RU1,RU2, and RV1,RV2,RUV1,RUV2), where one or more of the functions f, g, and h, change from one equation to another.

B4. Linear Combinations of multi-dimensional Fredholm-Volterra Integral Equations (RF1,RF2,RU1,RU2, and RV1,RV2,RUV1,RUV2), where none, one, two, or more of the functions f, g, and h, change from one equation to another.

Many other types of Integral/integro-differential equations can be solved using the method of the present invention. For example, for a known differentiable function z, the following integral equations can be solved.

B5. ROXIE equivalent to Fredholm Integral Equation of the Third Kind
z(g(x),f(x))=∫_{x-b}^{x-a}h(x−α,α)f(x−α)dα (RF3) (B5.1)
In the case of the equation above and others that follow, we leave out listing equivalent standard form equations as they are obvious. These standard form equations are first converted to one of the Rao-X equation (ROXIDE/ROXIE) form which are listed here.

The method of converting a standard form equation to Rao-X equation form is determined by the derivation steps of RLT/GRLT and IRLT/IGRLT. This method involves two main steps. These steps are clear from the many examples presented here. The first step is to replace f(α) in the integrand by f(x−α) and derivatives of the form f^{(k)}(α) in the integrand by f^{(k)}(x−α). If terms of the form f(x) or f^{(k)}(x) and g(x) or g^{(k)}(x) are present inside or outside the integrand, they are not changed. The second step is to apply the RLT or GRLT to obtain h from h′ and determine the limits of integration. Generally, in the integrand, a variable x that appears as an argument of the kernel h′ becomes (x−α) and appears as an argument of h. An argument α appearing in h′ will remain the same and appears as the corresponding argument of h. If x or functions of x appear in the integrand but does not play a role in changing h′ to h, they are not changed. The relation between h and h′ is determined by the constraint that the value of the two integrands (one with h and another with h′) are equal. The additional constraint is that the integral terms (i.e. integration of integrands) must be equal. This determines the limits of integration.

B6. ROXIE for Volterra Integral Equation of the Third Kind (RV3)
z(g(x),f(x))=∫₀^{x-a}h(x−α,α)f(x−α)dα (RV3) (B6.1)

B7. ROXIE for Urysohn Integral Equation of the Third Kind (RU3)
z(g(x),f(x))=∫_{x-b}^{x-a}h(x−α,α,f(x−α))dα (RU3) (B7.1)

B8. ROXIE for Urysohn-Volterra Integral Equation of the Third Kind (RUV3)
z(g(x),f(x))=∫₀^{x-a}h(x−α,α,f(x−α))dα (RUV3) (B8.1)

B9. ROXIE for Urysohn Integral Equation of the Fourth Kind (RU4)
g(x)=f(x)+∫_{x-b}^{x-a}h(x−α,α,f(x−α),f(x))dα (RU4) (B9.1)

B10. ROXIE for Urysohn-Volterra Integral Equation of the Fourth Kind (RUV4)
g(x)=f(x)+∫₀^{x-a}h(x−α,α,f(x−α),f(x))dα (RUV4) (B10.1)

B11. ROXIE for Fredholm Integral Equation of the Fourth Kind (RF4)
z(g(x),f(x))=∫_{x-b}^{x-a}h(x−α,α,f(x−α),f(x))dα (RF8) (B11.1)

B12. ROXIE for Volterra Integral Equation of the Fourth Kind (RV4)
z(g(x),f(x))=∫₀^{x-a}h(x−α,α,f(x−a),f(x))dα (RV4) (B12.1)

B13. ROXIE for Hammerstein-Fredholm Integral Equation (RHF): First and Second Kinds
f(x)=∫_{x-b}^{x-a}h(x−α,α,g(x−α,f(x−α))dα (RHF1) (B13.1)
f(x)=g₁(x,f(x))+∫_{x-b}^{x-a}h(x−α,α,g₂(x−α,f(x−α))dα (RHF2) (B13.2)

B14. ROXIE for Hammerstein-Volterra Integral Equation (RHV): First and Second Kinds
f(x)=∫₀^{x-a}h(x−α,α,g(x−α,f(x−α))dα (RHV1) (B14.1)
f(x)=g₁(x,f(x))+∫₀^{x-a}h(x−α,α,g₂(x−α,f(x−α))dα (RHV2) (B14.2)

B15. Linear combinations of the above equations for one dimensional and multi-dimensional cases can also be solved.

Many types of Integro-Differential equations can also be solved by the applying RLT/GRLT. The resulting equations are referred to as Rao-X Integro-Differential Equations or ROXIDEs. For example, suppose that the k-th derivative of f with respect to x for some positive integer k is denoted by f^{(k)}. Then, integro-differential equations of the following kind can be solved.

B16. ROXIDE for Fredholm Integro-Differential equation of the Fist Kind (RFID1):
z(g(x),f⁽⁰⁾(x),f⁽¹⁾(x),f⁽²⁾(x), . . . ,f⁽ⁿ⁾(x))=∫_{x-b}^{x-a}h(x−α,α,f(x−α))dα (RFID1) (B16.1)

B17. ROXIDE for Volterra Integro-Differential equation of the First Kind (RVID1):
z(g(x),f⁽⁰⁾(x),f⁽¹⁾(x),f⁽²⁾(x), . . . ,f⁽ⁿ⁾(x))=∫₀^{x-a}h(x−α,α,f(x−α))dα (RVID1) (B17.1)

B18. ROXIDE for Fredholm Integro-Differential equation of the Second Kind (RFID2):
z(g(x),f⁽⁰⁾(x),f⁽¹⁾(x),f⁽²⁾(x), . . . ,f⁽ⁿ⁾(x))=∫_{x-b}^{x-a}h(x−α,α,f(x−α),f(x))dα (RFID2) (B18.1)

B19. ROXIDE for Volterra Integro-Differential equation of the Second Kind (RVID2):
z(g(x),f⁽⁰⁾(x),f⁽¹⁾(x),f⁽²⁾(x), . . . ,f⁽ⁿ⁾(x))=∫₀^{x-a}h(x−α,α,f(x−α),f(x))dα (RVID2) (B19.1)

B20. ROXIDE for Fredholm Integro-Differential equation of the Third Kind (RFID3):

$$z ( g ( x ) , {f}^{( 0 )} ( x ) , {f}^{( 1 )} ( x ) , {f}^{( 2 )} ( x ) , ⋯ , {f}^{( n )} ( x ) ) = {\int }_{x - b}^{x - a} h ( x - α , α , f ( x - α ) , g ( x ) , {f}^{( 0 )} ( x ) , {f}^{( 1 )} ( x ) , {f}^{( 2 )} ( x ) , ⋯ , {f}^{( n )} ( x ) ) ⅆ α \qquad ( RFID3 ) ( B20 .1 )$$

B21. ROXIDE for Volterra Integro-Differential equation of the Third Kind (RVID3):

$$z ( g ( x ) , {f}^{( 0 )} ( x ) , {f}^{( 1 )} ( x ) , {f}^{( 2 )} ( x ) , ⋯ , {f}^{( n )} ( x ) ) = {\int }_{0}^{x - a} h ( x - α , α , f ( x - α ) , g ( x ) , {f}^{( 0 )} ( x ) , {f}^{( 1 )} ( x ) , {f}^{( 2 )} ( x ) , ⋯ , {f}^{( n )} ( x ) ) ⅆ α \qquad ( RVID3 ) ( B21 .1 )$$

B22. ROXIDE for Fredholm Integro-Differential equation of the Fourth Kind (RFID4):

$$z ( g ( x ) , {f}^{( 0 )} ( x ) , {f}^{( 1 )} ( x ) , {f}^{( 2 )} ( x ) , ⋯ , {f}^{( n )} ( x ) ) = {\int }_{x - b}^{x - a} h ( x - α , α , x , f ( x - α ) , g ( x ) , {f}^{( 0 )} ( x ) , {f}^{( 1 )} ( x ) , {f}^{( 2 )} ( x ) , ⋯ , {f}^{( n )} ( x ) , g ( x - α ) , {f}^{( 1 )} ( x - α ) , {f}^{( 2 )} ( x - α ) , ⋯ , {f}^{( n )} ( x - α ) ) ⅆ α \qquad ( RFID4 ) ( B22 .1 )$$

B23. ROXIDE for Volterra Integro-Differential equation of the Fourth Kind (RVID4):

$$z ( g ( x ) , {f}^{( 0 )} ( x ) , {f}^{( 1 )} ( x ) , {f}^{( 2 )} ( x ) , ⋯ , {f}^{( n )} ( x ) ) = {\int }_{0}^{x - a} h ( x - α , α , x , f ( x - α ) , g ( x ) , {f}^{( 0 )} ( x ) , {f}^{( 1 )} ( x ) , {f}^{( 2 )} ( x ) , ⋯ , {f}^{( n )} ( x ) , g ( x - α ) , {f}^{( 1 )} ( x - α ) , {f}^{( 2 )} ( x - α ) , ⋯ , {f}^{( n )} ( x - α ) ) ⅆ α \qquad ( RVID4 ) ( B23 .1 )$$

Expand all functions with arguments (x−α) in Taylor series around (x) and set f^{(m)}(x)=0 for m>N.

B24. ROXIDE Fredholm Coupled System of Equations (RFCS)

$${z}_{i} ( g ( x ) , {f}^{( 0 )} ( x ) , {f}^{( 1 )} ( x ) , {f}^{( 2 )} ( x ) , ⋯ , {f}^{( n )} ( x ) ) = {\sum }_{j = 1}^{K} {\int }_{x - b}^{x - a} {h}_{ij} ( x - α , α , x , f ( x - α ) , g ( x ) , {f}^{( 0 )} ( x ) , {f}^{( 1 )} ( x ) , {f}^{( 2 )} ( x ) , ⋯ , {f}^{( n )} ( x ) , g ( x - α ) , {f}^{( 1 )} ( x - α ) , {f}^{( 2 )} ( x - α ) , ⋯ , {f}^{( n )} ( x - α ) ) ⅆ α \\ \begin{matrix}i = 1 , 2 , 3 , ⋯ , {N}^{′} , & {N}^{′} \geq N , & n \leq N ,\end{matrix} \\ {f}^{( m )} ( x ) = 0 for m > N . \qquad ( RFCS ) ( B24 .1 )$$

Expand all functions with arguments (x−α) in Taylor series around (x) and set f^{(m)}(x)=0 for m>N.

B25. ROXIDE Volterra Coupled System of Equations (RVCS)

$${z}_{i} ( g ( x ) , {f}^{( 0 )} ( x ) , {f}^{( 1 )} ( x ) , {f}^{( 2 )} ( x ) , ⋯ , {f}^{( n )} ( x ) ) = {\sum }_{j = 1}^{K} {\int }_{0}^{x - a} {h}_{ij} ( x - α , α , x , f ( x - α ) , g ( x ) , {f}^{( 0 )} ( x ) , {f}^{( 1 )} ( x ) , {f}^{( 2 )} ( x ) , ⋯ , {f}^{( n )} ( x ) , g ( x - α ) , {f}^{( 1 )} ( x - α ) , {f}^{( 2 )} ( x - α ) , ⋯ , {f}^{( n )} ( x - α ) ) ⅆ α \\ \begin{matrix}i = 1 , 2 , 3 , ⋯ , {N}^{′} , & {N}^{′} \geq N , & n \leq N ,\end{matrix} \\ {f}^{( m )} ( x ) = 0 for m > N . \qquad ( RVCS ) ( B25 .1 )$$

Expand all functions with arguments (x−α) in Taylor series around (x) and set f^{(m)}(x)=0 for m>N.

B26. Linear combinations of the above equations for one dimensional and multi-dimensional cases can also be solved.

B27. Any Linear Combinations of one-dimensional, multi-dimensional (multi-variable), combinations of any of the above equations where none, one, two, or more of the functions f, g, and h, change from one equation to another.

### 7. APPARATUS

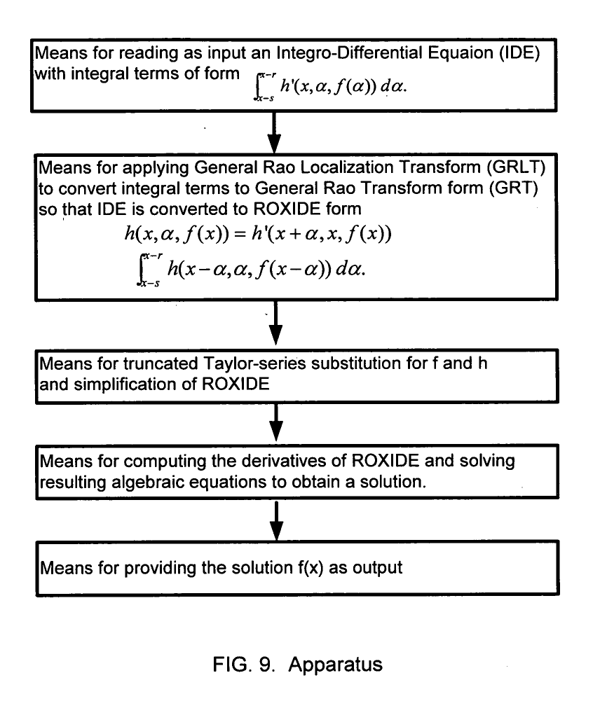

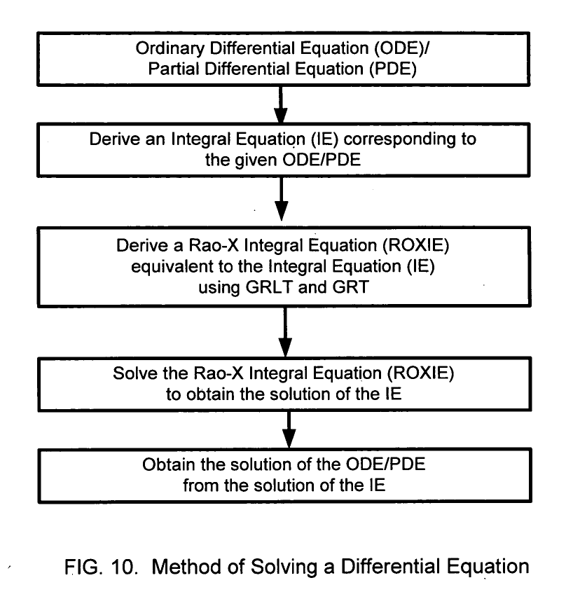

The Apparatus of the present invention is shown in FIG. 9. The method of the present invention suggests an apparatus for solving an integro-differential equation. The different parts of the apparatus correspond to the different steps in the method of the present invention. This apparatus of the present invention includes:
1. A means for reading as input an integro-differential equation with integral terms;
2. A means for applying General Rao Localization Transform to integral terms to convert the integral terms to General Rao Transform form and derive an integro-differential equation in ROXIDE form;
3. A means for truncated Taylor-series substitution for f and h and simplification of mathematical expressions derived from ROXIDEs;
4. A means for computing the derivatives of ROXIDEs and solving resulting algebraic equations to obtain a solution f(x) for the integro-differential equation; and
5. A means for providing the solution f(x) of the integro-differential equation as output.

### 8.0 CONCLUSION

Methods and apparatus are described for efficiently computing the solution of a large class of linear and non-linear integral and integro-differential equations and systems of equations. The methods are also useful in solving ordinary and partial differential equations which can be converted to integral or integro-differential equations. The methods are based on the new Rao Transform and Rao Localization Transform and their General versions. The methods are unified, localized, and efficient. These methods are useful in many applications including engineering, medicine, science, and economics.

The method of the present invention is useful in solving many types of integral and integro-differential equations that are not explicitly listed here. Such equations are within the scope of the present invention as defined by the claims.

While the description in this report of the methods, apparatus, and applications contain many specificities, these should not be construed as limitations on the scope of the present invention, but rather as exemplifications of preferred embodiments thereof. Further modifications and extensions of the present invention herein disclosed will occur to persons skilled in the art to which the present invention pertains, and all such modifications are deemed to be within the scope and spirit of the present invention as defined by the appended claims and their equivalents thereof.

What is claimed is:

1. A method of solving an Integro-Differential Equation (IDE) with an integral term having an integrand dependent on an integration variable α, an independent variable x, a kernel function h′ which depends on both x and α, and an unknown function f which is dependent on a single variable, said method comprising the steps of
a. expressing said IDE in an equivalent Rao-X Integro-Differential Equation (ROXIDE) form wherein said integrand becomes dependent on f(x−α) instead of f(α), using, if necessary, the following two steps:
i. finding a localized kernel function h of said kernel function h′ in said equation using the General Rao Localization Transform; and
ii. expressing said integral term in said IDE in a standard localized form of General Rao Transform using said localized kernel function h and said unknown function f,
b. replacing f(x−α) with a truncated Taylor-series expansion of f(x−α) around x up to an integer order N, and setting all higher order terms to zero;
c. replacing terms of said localized kernel function h dependent on x−α and α with its truncated Taylor series expansion around the point x and α;
d. simplifying the resulting expression by grouping terms based on the unknowns which are the derivatives of f with respect x at x denoted by f⁽ⁿ⁾ for an n-th order derivative; moving the unknowns f⁽ⁿ⁾ to be outside the definite integrals in integral terms that arise during simplification and grouping of terms;
e. deriving a system of at least N equations by taking various derivatives with respect to x of the equation derived in Step (d), and setting to zero any derivatives of f of order greater than N to zero; computing symbolically or numerically, all definite integrals using the given value of x if needed, and obtaining a system of at least N equations; and
f. Solving said system of at least N equations obtained in Step (e) to obtain the unknown f⁽⁰⁾ and providing it as the desired solution f(x) of said IDE.

2. The method of claim 1 wherein said ROXIDE is a Rao-X Integral Equation (ROXIE).

3. The method of claim 1 wherein the result of Step (c) is used to efficiently compute the value of said integral term when said unkown function is given.

4. The method of claim 2 wherein said ROXIE is for a Fredholm Integral Equation of the First Kind.

5. The method of claim 2 wherein said ROXIE is for a Fredholm Integral Equation of the Second Kind.

6. The method of claim 2 wherein said ROXIE is for a Volterra Integral Equation of the First Kind.

7. The method of claim 2 wherein said ROXIE is for a Volterra Integral Equation of the Second Kind.

8. The method of claim 2 wherein said ROXIE is for a Urysohn Integral Equation of the First Kind.

9. The method of claim 2 wherein said ROXIE is for a Urysohn Integral Equation of the Second Kind.

10. The method of claim 2 wherein said ROXIE is for a Urysohn-Volterra Integral Equation of the First Kind.

11. The method of claim 2 wherein said ROXIE is for a Urysohn-Volterra Integral Equation of the Second Kind.

12. The method of claim 2 wherein said ROXIE is for a Fredholm Integral Equation of the Third Kind.

13. The method of claim 2 wherein said ROXIE is for a Volterra Integral Equation of the Third Kind.

14. The method of claim 2 wherein said ROXIE is for a Urysohn Integral Equation of the Third Kind.

15. The method of claim 2 wherein said ROXIE is for a Urysohn-Volterra Integral Equation of the Third Kind.

16. The method of claim 2 wherein said ROXIE is for a Urysohn Integral Equation of the Fourth Kind.

17. The method of claim 2 wherein said ROXIE is for a Urysohn-Volterra Integral Equation of the Fourth Kind.

18. The method of claim 2 wherein said ROXIE is for a Fredholm Integral Equation of the Fourth Kind.

19. The method of claim 2 wherein said ROXIE is for a Volterra Integral Equation of the Fourth Kind.

20. The method of claim 2 wherein said ROXIE is for a Hammerstein-Fredholm Integral Equation of the First Kind.

21. The method of claim 2 wherein said ROXIE is for a Hammerstein-Fredholm Integral Equation of the Second Kind.

22. The method of claim 2 wherein said ROXIE is for a Hammerstein-Volterra Integral Equation of the First Kind.

23. The method of claim 2 wherein said ROXIE is for a Hammerstein-Volterra Integral Equation of the Second Kind.

24. The method of claim 1 wherein said ROXIDE is for a Fredholm Integro-Differential Equation of the First Kind.

25. The method of claim 1 wherein said ROXIDE is for a Fredholm Integro-Differential Equation of the Second Kind.

26. The method of claim 1 wherein said ROXIDE is for a Fredholm Integro-Differential Equation of the Third Kind.

27. The method of claim 1 wherein said ROXIDE is for a Fredholm Integro-Differential Equation of the Fourth Kind.

28. The method of claim 1 wherein said ROXIDE is for a Volterra Integro-Differential Equation of the First Kind.

29. The method of claim 1 wherein said ROXIDE is for a Volterra Integro-Differential Equation of the Second Kind.

30. The method of claim 1 wherein said ROXIDE is for a Volterra Integro-Differential Equation of the Third Kind.

31. The method of claim 1 wherein said ROXIDE is for a Volterra Integro-Differential Equation of the Fourth Kind.

32. The method of claim 1 wherein said integration variable α and said independent variable x are multi-dimensional vectors.

33. The method of claim 2 wherein said integro-differential equation (IDE) is the result of converting a differential equation to said IDE whereby the solution of said IDE provides the solution of said differential equation.

34. The method of claim 32 wherein said integro-differential equation (IDE) is the result of converting a partial differential equation to said IDE whereby the solution of said IDE provides the solution of said partial differential equation.

35. An apparatus for solving an integro-differential equation which includes:
a. A means for reading as input an integro-differential equation with integral terms;
b. A means for applying General Rao Localization Transform to convert integral terms to General Rao Transform form and derive an integro-differential equation in ROXIDE form;
c. A means for truncated Taylor-series substitution and simplification of mathematical expressions derived from ROXIDEs;
d. A means for computing the derivatives of ROXIDEs and solving resulting algebraic equations to obtain a solution for said integro-differential equation; and
e. A means for providing the solution of said integro-differential equation as output.

36. The apparatus of claim 35 which further includes a means for converting or reformulating differential equations into integral equations.
